(19) United States
(12) Patent Application Publication
(10) Pub. No.: US 2013/0222525 A1
(43) Pub. Date: Aug. 29, 2013

(54) SYSTEM AND METHOD FOR REMOTELY LOCATING AN OBJECT IN REAL TIME VIA A NETWORK

(71) Applicant: Franco FORGHIERI, Emmering (DE)

(72) Inventor: Franco FORGHIERI, Emmering (DE)

(21) Appl. No.: 13/546,675

(22) Filed: Jul. 11, 2012

(30) Foreign Application Priority Data
Feb. 29, 2012 (GB) 1203495.5

(51) Int. Cl. H04N 7/15

(52) U.S. Cl. 348/14.08; 348/E07.083

(57) ABSTRACT

A method for remotely locating an object in real time via a network comprises sending a request from a user to a server describing an object to be geographically located remotely via the network, identifying a possible geographic area in which the object is expected to be geographically located, determining a messenger having a geographical location within a predetermined distance of the possible geographic area from a table comprising messengers having known geographical locations, the identity and geographical location of the user being unknown to the messenger, sending an assignment including the possible geographical area from the server to the messenger enabling the messenger to proceed to the possible geographic area to provide a real-time video image is sent from the messenger to the user to enable the user to visually determine whether the object is geographically located within the field of view.

### FIELD

The present application relates to a system and method for remotely locating an object in real time via a network.

### BACKGROUND

It is possible to search for and obtain products in a number of ways. For example, a buyer may go to a physical retail store and look around the store to identify a particular product. Alternatively, the buyer may search for a particular product online on the interne and select the products from visual images depicting the product on a website.

In person shopping at physical retail store locations has an advantage in that the buyer can examine the physical product before deciding whether to purchase the product. However, additional information about the product may be limited in the physical retail store location so that the buyer may have to search for a sales assistant to obtain more information about the product. The buyer is then reliant on the knowledge of the sales assistant as to whether additional information and the additional information required can be provided.

One advantage of online shopping is that the amount of information given about a product is potentially much larger. However, while online shopping, the buyer does not have the opportunity to examine and handle the physical product before purchasing. If, once the product has been delivered, the buyer does not like the physical product, the buyer has the additional work of returning the product to the supplier.

US 2011/0300831 discloses an interactive personalised e-experience system and method for visual voice mail in which additional services can be provided to a user in a physical retail location by wireless technologies. For example, the user can request sales associate help and product information etc. wirelessly whilst in the physical retail location.

However, such a system may not provide all of the information that the buyer requires, particularly in the case that the buyer does not yet know exactly which product he would like to purchase. This may be the case if the buyer is not sure which model of a particular product he wishes to purchase, for example.

Therefore, methods suitable for assisting a buyer in the purchase of a product are desirable.

### SUMMARY

A method for remotely locating an object in real time via a network is provided that comprises the following: A request may be sent from a user to a server. The request may describe an object to be geographically located remotely via the network. A possible geographic area in which the object is expected to be geographically located is identified. At the server, a messenger may be determined from a table comprising messengers having known geographical locations. A messenger may be determined that has a geographical location within a predetermined distance of the possible geographic area. The identity and geographical location of the user may be unknown to the messenger. An assignment including the possible geographical area may be sent from the server to the messenger enabling the messenger to proceed to the possible geographic area. After the messenger is positioned within the possible geographic area, a video connection may be established between the messenger and the user via a network capable of transferring real-time video images. Whilst a real-time video image may be sent from the messenger to the user, instructions may be sent from the user to the messenger to control the field of view represented by the video signal in real time in order to enable the user to visually determine whether the object is geographically located within the field of view.

A server is also provided which comprises receiver apparatus for receiving a request from a user describing an object to be geographically located and a possible geographic area in which the object is expected to be geographically located, storage apparatus for storing a table comprising a plurality of messengers having known geographical locations, determining apparatus for determining a messenger having a geographical location within a predetermined distance of the possible geographic area from the table, the identity and geographical location of the user being unknown to the messenger, and transmitter apparatus for sending an assignment including the possible geographical area from the server to the messenger enabling the messenger to proceed to the possible geographic area.

### BRIEF DESCRIPTION OF THE DRAWINGS

The accompanying drawings are presented to aid in the description of aspects of the disclosure and are provided solely for illustration of the aspects and not limitation thereof.

FIG. 1 illustrates a system for remotely locating an object in real time via a network;

FIG. 2 illustrates a schematic diagram of computing apparatus having components suitable for use in the methods described herein;

FIG. 3 illustrates a table stored by a server connected to the network;

FIG. 4a illustrates the geographical arrangement of a possible area in which an object may be located and the known geographical locations of a plurality of messengers;

FIG. 4b illustrates a diagram of the determination of a messenger from a plurality of messengers;

FIG. 5 illustrates a first step in the method for remotely locating objects in real time via the network according to one embodiment;

FIG. 6 illustrates a second step in a method for remotely locating an object in real time by the network according to the first embodiment;

FIG. 7 illustrates a method for remotely locating an object in real time via a network according to a second embodiment; and

FIG. 8 illustrates the payment of an invoice after remotely locating an object in real time via a network.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the disclosure or the claims. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects.

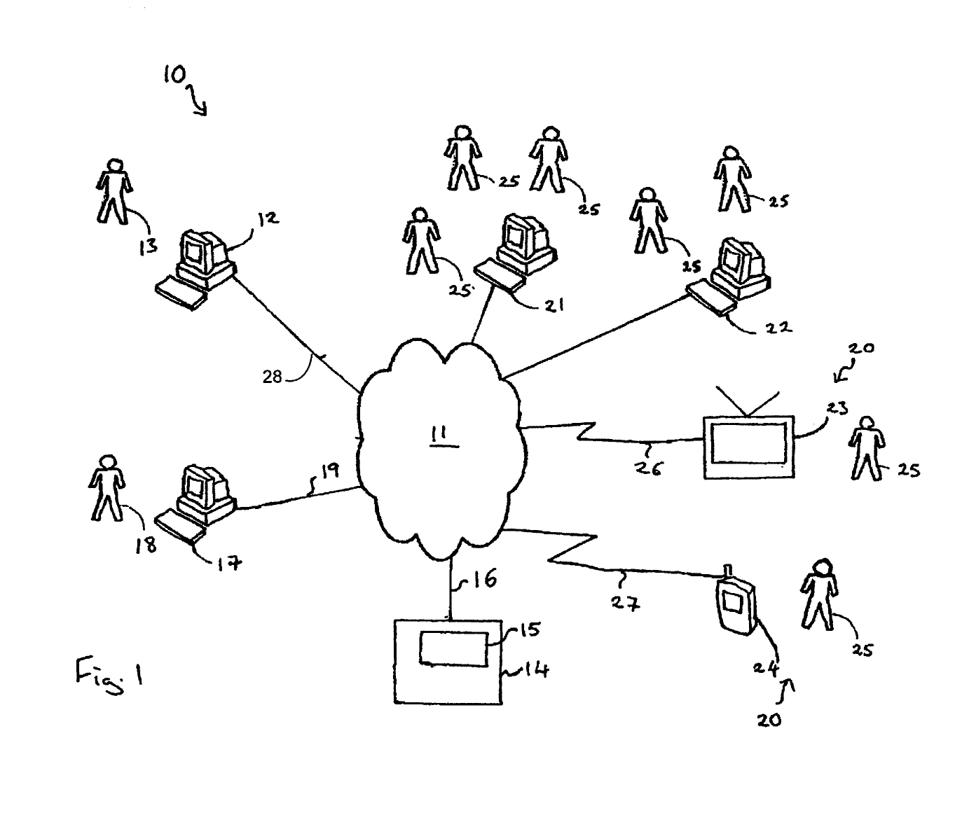

FIG. 1 illustrates a system 10 for remotely locating an object in real time via a network 11. In this embodiment, the network 11 may be the Internet. The system 10 comprises computer apparatus 12 which may be associated with a user 13. The computer apparatus 12 may be connected to the network 11 by means of standard Internet compatible connections 28 and protocols. The system 10 further comprises a server 14 including a table 15 that may comprise data describing messengers having known geographical locations. The server 14 may also connect to the network 11 by a standard connection 16. The system 10 is not limited to a single computer apparatus 12 associated with a single user 13 but may also be used by a number of users and computer apparatus connected to the network 11 as illustrated by computer apparatus 17, user 18 and connection 19 in FIG. 1.

The system 10 further comprises a plurality of messengers indicated generally with the reference number 20. In this embodiment the system 10 may include a first hub 21 in the form of computer apparatus having a first fixed geographical location and a second hub 22 in the form of computer apparatus having a second fixed geographical location which may be different from the first fixed geographical location. Each hub 21, 22 may be associated with a plurality of messengers 20. The system 10 may also include mobile computing devices 23 and 24 which may be capable of establishing a video connection and, optionally also an audio connection, between the device itself and the computer apparatus 12 associated with the user 13 via the network 11.

In this embodiment, the mobile computing device 23 is illustrated as a tablet computer and the mobile computing device 24 is illustrated as a smart phone. The mobile computing device 23 and the mobile computing device 24 may each be associated with a person 25 who is able to carry mobile computing devices 23 and 24 so as to change the geographical location of the mobile computing device 23, 24 and the field of view represented by the real-time video images which are sent via the network 11 to thee computer apparatus 12 associated with user 13. The person 25 and the mobile computing device 23 or 24 comprise a messenger 20.

FIG. 1 illustrates that the mobile computing devices 23, 24 may be connected to the network 11 wirelessly by connections 26 and 27 respectively. The mobile computer devices 23, 24 may be associated with one or more of the hubs 21 and 22 and may be carried by one of the plurality of people 25 associated with each of the hubs 21, 22.

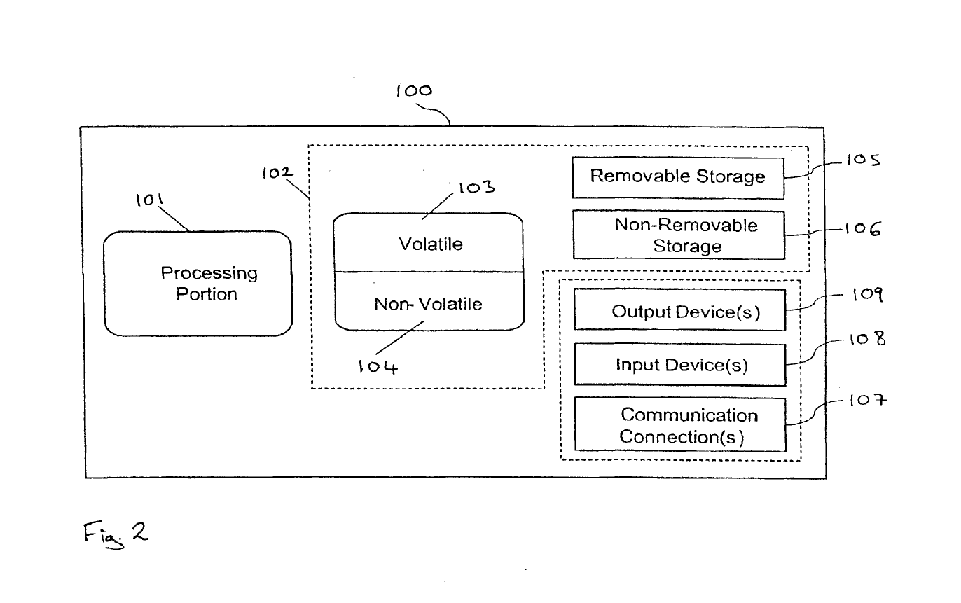

FIG. 2 illustrates a schematic diagram of computing apparatus 100 suitable for use in the methods described herein.

The computing apparatus 100 may include at least one processing portion 101 and at least one memory portion 102. The memory portion 102 may store any information utilized in conjunction with transmitting, receiving, and/or processing video and audio signals, data and/or content. The memory portion 102 may be volatile (such as RAM) 103, non-volatile (such as ROM, flash memory, etc.) 104, or a combination thereof. The computing apparatus 100 may also include additional storage (removable storage 105 and/or non-removable storage 106) including, but not limited to, magnetic or optical disks, tape, flash, smart cards or a combination thereof. Computer storage media, such as memory and storage elements 103, 104, 105 and 106 may include volatile and nonvolatile, removable and non-removable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processing portion 101. Any such computer storage media may be part of the computing apparatus 100.

The computing apparatus may also contain the communications connection(s) 107 that allow the computing apparatus 100 to communicate with other devices, for example through a network as illustrated in FIG. 1. Communications connection(s) 107 is an example of communication media. Communication media typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection as might be used with a land line telephone, and wireless media such as acoustic, RF, optical, cellular, and other wireless media. The term computer-readable media as used herein includes both storage media and communication media. The computing apparatus 100 also may have input device(s) 108 such as keyboard, keypad, mouse, pen, voice input device such as a microphone, touch input device such as a touch sensitive display, camera etc. Output device(s) 109 such as a display, speakers, a printer, etc. also may be included depending on the type of computing apparatus.

The mobile computing devices 23, 24 illustrated in FIG. 1 may include a communication connection capable of transmitting real-time video images to the network 11, a touch screen input device, a camera for capturing real-time images, a receiver for receiving audio instructions from the user, microphone for receiving audio signals local to the mobile computing device 23, 24, and speakers for transmitting audio instructions from the user 13 to both the person 25 of the messenger 20 as well as to a third party with whom the user 13 wishes to conduct a conversation in real time via the network 11.

The computer apparatus 12 associated with the user 13 and illustrated in FIG. 1 may include a communication connection capable of transmitting audio signals to the network 11, a keyboard and a microphone as input devices, receivers for receiving real-time video images from the messenger 20 and audio signals from both the person 25 as well as from a third party with whom the user 13 wishes to conduct a conversation in real time via the network 11.

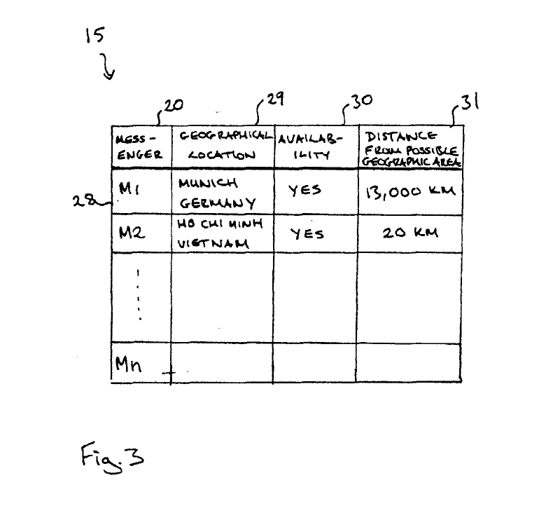

FIG. 3 illustrates a schematic diagram of the table 15 stored in the server 14 illustrated in FIG. 1. The table 15 comprises a plurality of fields including data describing a plurality of messengers 20 which are each denoted with an identification number 28. For each messenger 20, the table 15 stores the geographical location 29 of the messenger 20 which, this embodiment, is Munich, Germany for messenger M1 and Ho Chi Minh, Vietnam for messenger M2. In this embodiment, the table 15 also includes the availability 30 of the messenger as a function of time.

In further non-illustrated embodiments, the table may also includes one or more of the following fields; area over which the messenger is mobile, for example within a radius of 20 km or 100 km, specialist knowledge, for example, vintage cars, languages spoken, for example English and Mandarin, and a performance rating. The performance rating may be built up from the ratings given to the messenger from previous users who have used the services of this messenger.

The server 14 may receive a request from the user 13 including the possible geographic area in which the object may be expected to be found and the preselected point in time at which a messenger should be present at the possible geographic area, the table may be updated to indicate the availability of the plurality of messengers at this preselected time and the distance 31 of the messenger from the possible geographic area of the object to be located. The user 13 may select a messenger from this modified table 15. Afterwards, the table 15 may be updated to indicate that the chosen messenger is unavailable at this time.

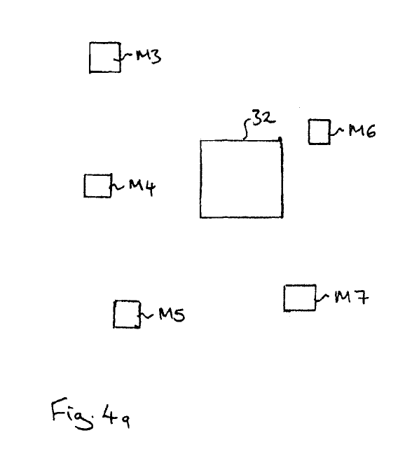

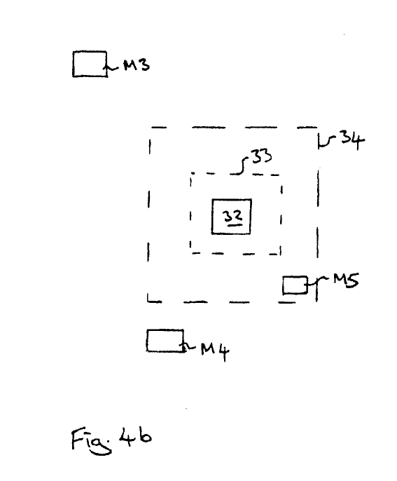

FIG. 4a illustrates a diagram of a possible geographic area 32 in which an object may be expected to be located and the known geographical locations of a plurality of messengers indicated with the reference numbers M3, M4, M5, M6 and M7. FIG. 4a illustrates that messenger M6 may be geographically located closer to the possible geographical area 32 than the other messengers. Messenger M6 may be selected to proceed to the possible geographic area 32 in order to remotely locate the object in real time.

FIG. 4b illustrates an embodiment in which the most suitable messenger may be identified from a plurality of messengers. The possible geographic area of the object is illustrated with box 32. A first predetermined distance represented by the dashed line 33 from the possible geographic area 32 may be set. This predetermined distance may be 10 km, for example. In this embodiment none of the messengers M3, M4 or M5 lie within the predetermined distance.

In this case, the predetermined distance may be increased to, for example, 25 km as represented by the dashed line 34. The messenger M5 lies within its predetermined distance of 25 km to the possible geographic area 32 and may, therefore, be selected as the most suitable messenger to remotely locate the object. The predetermined distance may be selected by the user. If two or more messengers are located within the predetermined distance, one of the messengers may be selected on the basis of one or more of a number of predetermined criteria. These criteria may include distance to the possible geographic area, availability and cost of the messenger, for example. The user or the server may select the messenger.

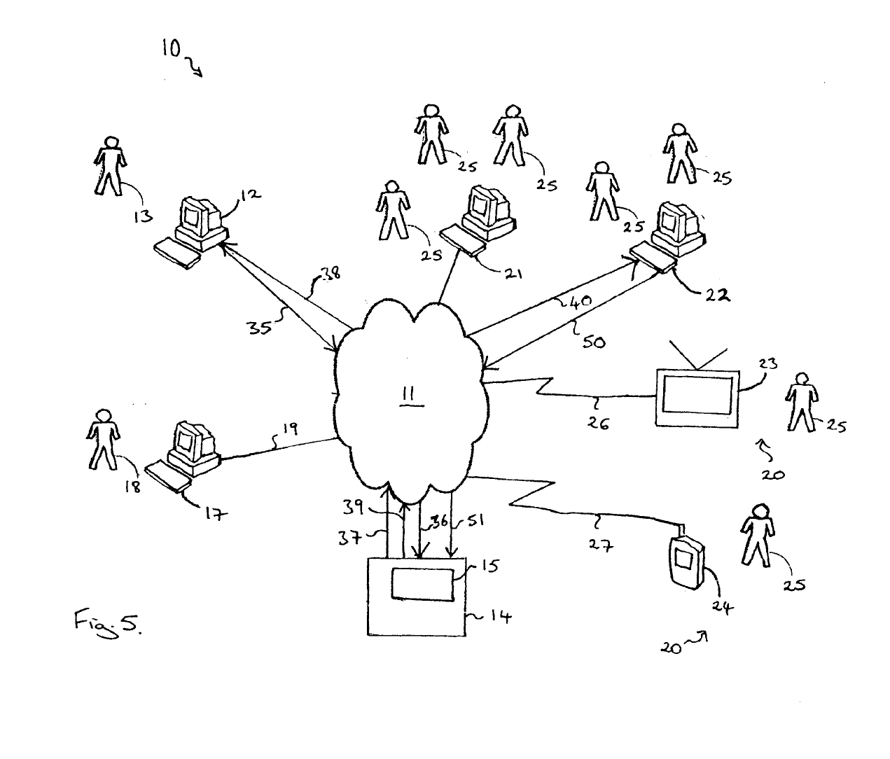

FIG. 5 illustrates a first step in an embodiment method for remotely locating an object in real time via the network 11 using the system 10 illustrated in FIG. 1. The object may be located remote from the user 13. The user 13 sends a request illustrated by the arrow 35 via the network 11 to the server 14 as represented by the arrow 36. The request describes an object to be geographically located remotely via the network 11. The request may include a possible geographic area in which the object may be expected to be located and a pre-selected time at which the messenger should be physically present at the possible geographical area.

At the server 14, a suitable messenger may be located from the table 15 of messengers 20 having known geographical locations. The most suitable messenger 20 may be determined from the plurality of messengers 20 by a geographical location being within a predefined distance of the possible geographic area Data identifying the messenger may be returned to the user 13 from the server 14 via the network 11 as is illustrated by the arrow 37 between the server 14 and the network 11 and the arrow 38 from the network 11 to the computer apparatus 12 associated with the user 13. The data includes a contact ID for the second hub 22 which may be determined to be a suitable messenger for locating the object within the possible geographic area. The server 14 may also send an assignment to the hub 22 via the network 11, as represented by the arrows 39, 40, including the information describing the possible geographic location to which the messenger should proceed and the time at which the messenger should be positioned in the possible geographic area. The second hub 22 may send confirmation data to the server 14 which may be forwarded to the user 13 to confirm that the hub will carry out the assignment. The confirmation connection is illustrated by arrows 50 and 51.

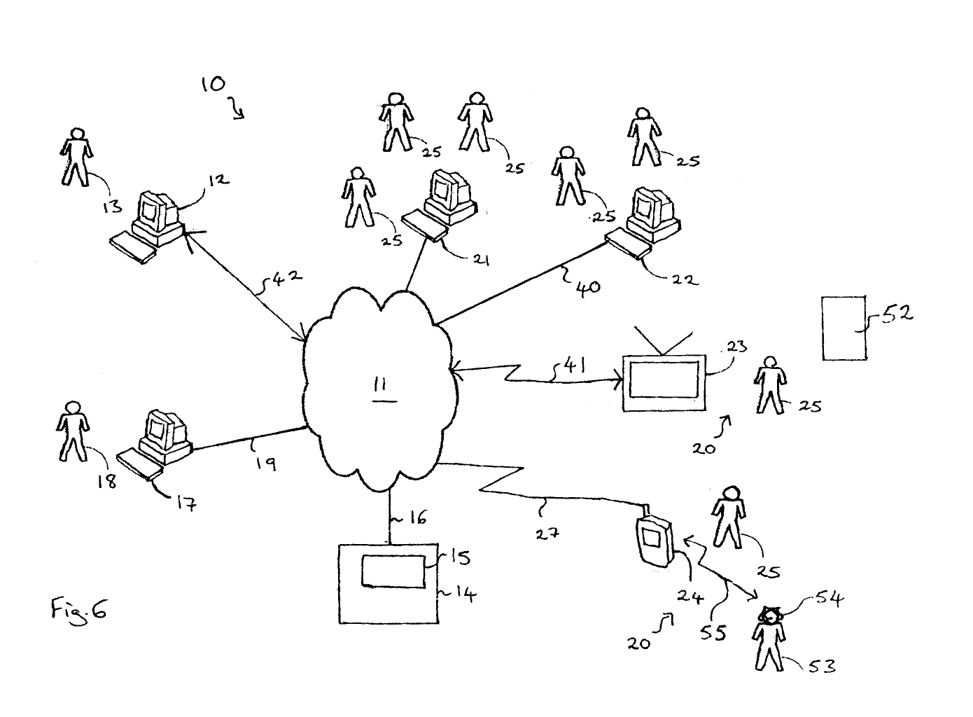

FIG. 6 illustrates a second step in the embodiment method for remotely locating the object in real time via the network 11. The messenger 20 in the form of the person 25 and mobile computing device 23 may be present at the possible geographical area in which the object may be expected to be located. In the second step, a video connection between the mobile computing device 23 of the messenger 20 and the computer apparatus 12 associated with user 13 may be established via the network 11 by means of a wireless connection between the mobile computing device 23 and the network 11. The connection between the computer apparatus 12 associated with the user 13 and the network 11 may be wired or wireless and may further include an audio connection. The video connection and, if present, the audio connection are represented by the arrows 41, 42. The video connection 41, 42 and the network 11 are capable of transferring real-time video images and, optionally, audio signals from the mobile computing device 23 to the computer apparatus 12.

After the video connection is established, a real-time video image is sent from the mobile computing device 23 to the computer apparatus 12 associated with the user 13. Whilst real-time video images are being sent, the user 13 may send instructions via the computer apparatus 12, the video connection 41, 42 and the network 11 to the mobile computing device 23 which enable the field of view represented by the video signal sent by the mobile computing device 23 to be adjusted in order that the user 13 may visually determine whether the object 52 is geographically located within the field of view of the mobile computing device 23. The field of view of the mobile computing device 23 may be adjusted by the person 25 carrying the mobile computing device 23. The person 25 may receive instructions from the user via an audio signal to enable him to adjust the field of view as desired by the user 13.

The connection between the user 13 and a messenger 20 or, more particularly, between the computer apparatus 12 associated with user 13 and mobile computing device 23 associated with the messenger 20 may be sent via by means of Audio and Video protocols. However, any protocol capable of transmitting speech and video via the internet may be used. The location of the object with the aid of the video connection may be carried out independently of the second hub 22 and the server 14 which were involved in the first step of the process.

If the user 13 determines that the object to be located remotely from the user 13 is positioned within the field of view represented by the video signal captured by the computing apparatus 23, the user 13 may send instructions that add to the further actions of the person 25. For example, the user 13 may request that the person 25 purchases the object 52 and then arranges for the object to be packed and sent to the user 13 by postal or courier services. The user 13 may request that the person 25 physically move the object 52 so that the user 13 may see the rear side of the object, for example. Alternatively, the user 13 may not wish to purchase the object 52 and may simply request the messenger 20 to halt. The video connection may be stopped at this stage.

In some embodiments, the mobile computing device 23, 24 may be used in such a way that the user 13 can communicate with an object 52 in the form of a person or with a third party 53 who is not associated with the mobile computing device 23, 24. For example, the speaker or speakers of the mobile computing device 23, 24 may be adjusted such that the received audio signal may be transmitted from the mobile computing device 23, 24 so that it may be audible in the vicinity of the mobile computing device 23, 24 and audible to a third party 53 or a person to be located. The microphone of the mobile computing device 23, 24 may have a sensitivity suitable to capture audio signals from the third party 53 so that these audio signals may be sent from the mobile computing device 23, 24 via the networking 11 to the computer apparatus 12 associated with the user 13. In some embodiments, the system further includes a headphone 54 which may be connected to the mobile computing device 23, 24 wirelessly, illustrated by arrow 55, or by a wired connection. The headphone 54 may comprise a microphone to capture audio signals from the third party 53 and speakers to enable the third party 53 to receive audio signals from the user 13.

The headphone 54 may be used by a third party 53 to converse in real time via the mobile computing device 23, 24, the network 11 and the computer apparatus 12 with the user 13. This conversation may be independent of, and inaudible to the person 25 of the messenger 20.

The user 13 can communicate with the third party 53 or third persons in real time even if the third party 53 or third persons does/do not have computer apparatus connected to the network 11. These embodiments may be useful if the user 13 wishes to communicate in real time with a third party 53 or third persons to discuss the object which is to be located remotely from the user 13. For example, the user may negotiate with a third party 53 over the price of the object or may simply converse with the third party 53 or third persons to gain further information over the object.

The identity and geographical location of the user 13 may be unknown to the messenger 20. Initially, before the user 13 may select the messenger 20, the geographical location and identity of the messenger 20 may be unknown to the user 13.

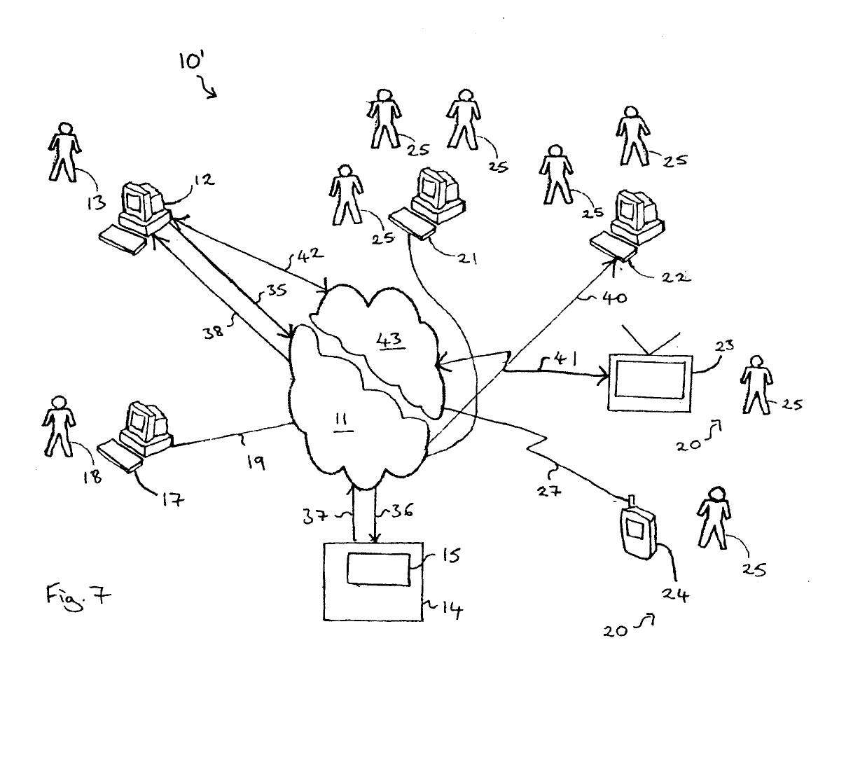

FIG. 7 illustrates a system 10′ for remotely locating objects in real time via the network according to a second embodiment. The second embodiment differs from the first embodiment in that two different networks are used in the second embodiment method. The first network 11 may be the Internet and may be used by the user 13 to select the messenger 20 from the table 15 stored at the server 14 as illustrated by the connection 35, 36 in FIG. 7. The first network 11 may also be used by the server 14 to send the contact details to the user 13 by computer apparatus 12, as illustrated by connection 37, 38, and by the server 14 to send an assignment to the hub 22, illustrated by connection 40, enabling the messenger to proceed to the possible geographic area of the object to be located remotely from the user 13 at a predetermined point in time.

The video connection and, if present, the audio connection between the computer apparatus 12 associated with the user 13 and the mobile computing device 23 associated with messenger 20 may be established via a second different network 43 which, in this embodiment, may be a packet switched mobile telephone network or a satellite connection using a satellite communication system. The connection between the computer apparatus 12 and the second network 43 may take place over connection 42 and the connection between the mobile computing device 23 of the messenger 20 and the network takes place over connection 41.

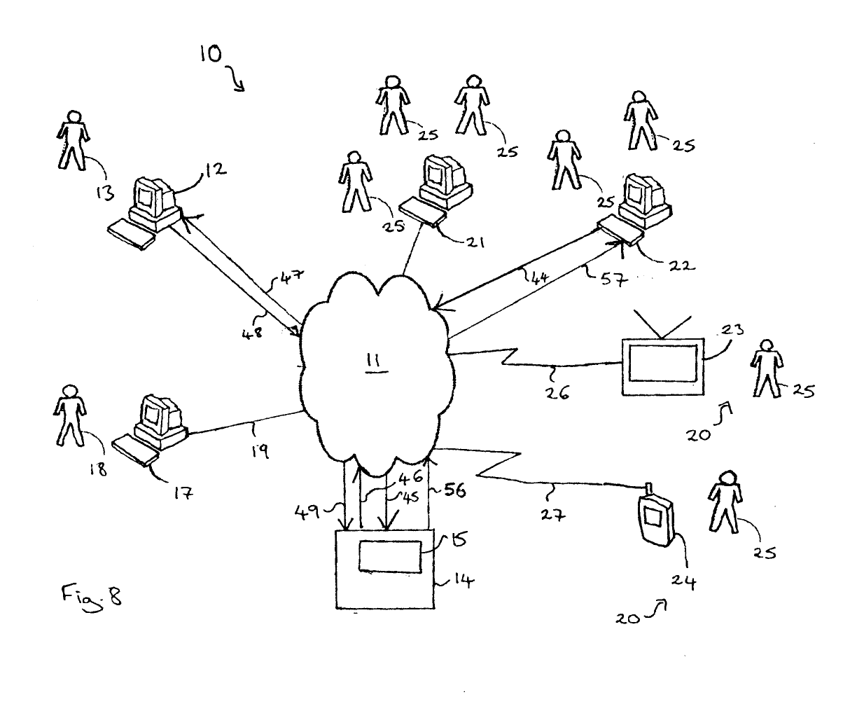

FIG. 8 illustrates payment of an invoice for an object which was remotely located by means of the mobile computing device 23. The person 25 associated with the mobile computing device 23 returns to the second hub 22 with the object. The second hub 22 may arrange for the object to be sent to the user 13 and may send an invoice to the server 14 by the network 11 as is illustrated by the arrows 44 and 45.

An invoice may be sent by the server 14 to the user 13, as is illustrated by the arrows 46 and 47 via the network 11 to the computer apparatus 12 associated with the user 13. The invoice may include the cost of the object as well as service charges of the second hub 22 and of the server 14. The user 13 may pay the invoice electronically by means of the computer apparatus 12 and the connection 48 and 49 to the server 14. The server 14 may send a payment to the second hub 22 by means of a connection illustrated by the arrows 56, 57. Payment may take place over a secure connection or by a known secure electronic payment method.

In addition to the mobile computing devices 23, 24 illustrated in the drawings, the messenger 20 may also include one or more of a camera, headset with microphone and speaker which are not integrated in the mobile computing device 23, 24 but are carried externally, for example as part of a hat, on the head, ear or shoulder.

In the case of a conversation with a third person, the messenger may also act as a translator. The camera may be directed towards the third person or persons so that they appear in the real-time video image sent to the user 13.

The mobile computing devices 23, 24 may be carried on an additional outer garment, such as a vest or coat, which may be adapted to hold the device such that the display, camera and speakers face outwardly from the person 25 wearing the garment.

In one embodiment, the messenger comprises a person 25 carrying a tablet computer and a second camera. The tablet computer 23 may comprise a display, a camera having a lens positioned on the same side of the tablet computer 23 as the display and at least one speaker. In some embodiments, the tablet computer 23 may be secured to a garment worn by the person 25 such that the display and camera face outwardly away from the person's body, for example the person's chest. The second camera may be positioned on the person's head. The two cameras may be directed in different directions so as to be able to transmitted two differing field of views to the user 13. This system for the messenger may make use of the ease of movement of a person's head compared to a person's body. For example, the tablet 23 may be used to display a field of view which does not have to be altered a great deal or very frequently and the camera attached to the head is used to provide a field of view which alters more often.

In embodiments in which the tablet computer 23 or other mobile computing device includes a camera system in which a first lens may be positioned on the same side of the computer or device as the display and a second lens may be positioned on the opposing side of the computer or device, the lens positioned on the same side of the computer or device as the display is used in the video connection with the computer device associated with the user.

Communication between the user 13 and the messenger 20 may be saved to provide a record, for example in the form of a data file. The data may be stored by a third party providing the communication connection between the user 13 and the messenger 20 or by the server 14. The data may also be stored by user 13 and/or the messenger 20.

The method according to embodiments of the invention enables a user to visually locate an object that may be remote from the user in real time via a network. The user need not be in the same location as the object in order to obtain visual images of the object. The object is, therefore, located remotely in real time via the video connection. The video connection is used to send real-time video images between a messenger who may be physically positioned in the geographical vicinity of the object and the user 13 who may be geographically located remote from the object. The user 13 may visually inspect the object in real time from the real-time video images. Such a method may be useful if the object that the user wishes to locate is expected to be located at a large distance from the user, for example in a different part of the country or in a different country.

The user 13 may be able to send a request to a server 14 which describes the object which is to be geographically located remote from the user 13. The possible geographic area in which the object may be expected to be geographically located is identified. This information may be provided by the user 13 to the server 14, for example if the user 13 already knows a particular retail location in which a particular product may be located. Alternatively, the user 13 may send a description of the object to the server 14 and the server 14 may provide one or more possible geographic locations of a suitable object to the user 13.

A table 15 comprising a plurality of messengers 20 having known geographical locations may be stored at the server. A particular messenger can be selected from the table 15 that is within a predetermined distance of the possible geographic area of the object. The predetermined distance may be the shortest distance between a messenger and the possible geographic area or any distance within a preselected boundary distance. This selection of the messenger enables the messenger to proceed to the possible geographic area within a reasonable timeframe. The messenger may receive an assignment from the server 14 to proceed to the possible geographic area. Therefore, the identity and geographical location of the user are unknown to the messenger as the messenger receives instructions from the server rather than directly from the user 13.

After the messenger 20 is positioned within the possible geographic area, a video link is established between the messenger 20 and the user 13 via a network. Whilst a real-time video image may be sent from the messenger 20 to the user 13, the user 13 may be able to send instructions to the messenger 20 to enable the messenger 20 to control the field of view represented by the video signal in real time. This may enable the user 13 to examine visually the object in real time as if the user were in the same geographical location as the object, although in reality the user may be remote from the object and visually examining the object by means of real-time video image transmitted over a network.

This method enables the user to be able to select a particular object from a plurality of objects within the field of view. Therefore, if the user cannot exactly describe the object such that the messenger would be able to select the desired object from the plurality of objects with a good chance of success, the use of the video connection and transfer of real-time video images along with instructions to change the field of view may be used to visually determine desired object and instruct the messenger to take to additional steps, such as to purchase the object and send the object to the user.

As used herein, the phrasing “messenger” does not denote a person who is mobile, but apparatus, such as a mobile computing device, that is able to establish a video connection with a network, capture real-time video images and transmit these via the network to another computing device.

The messenger may be associated with a person carrying such an apparatus. However, the messenger may also, in principle, be a machine which processes instructions from the user in a processor in order to change the position of the field of view.

The object is not limited to a physical object such as a product which the user wishes to purchase, but may also be a physical object which they user wishes to visually observe, for example, the physical condition of the vehicle, a patient, the results of a medical test, for example. The object may also be, or include a third person with which the user wishes to have real-time conversation. The apparatus which provides the video connection and, optionally, an audio connection with the user is provided by the messenger. The third person or persons is/are not associated with and is/are not provided with an apparatus that is capable of providing a connection to, or that is connected to the user by a video or other.

For example, the user may wish to buy a vintage car which is located in another country. The assignment from the user 13 sent by the server 14 may send a messenger 20 located in this different country to the car lot. Once the messenger 20 is in the car lot, the user 13 may send instructions directly to the messenger 20 via the real-time video link as to which vintage car the user 13 wishes to examine, physically examine the car by instructing the messenger to alter the field of view by walking around the car. The user 13 may discuss features of the vintage car and even negotiate a price with the seller of the vintage car. The user 13 can do all of this method without being in the same geographical location as the vintage car and without the seller having apparatus suitable for establishing a real-time video link with the user 13.

The video connection may be used to send video images in real time from the user to the messenger. This embodiment may be used if the user wishes to make a video call with a third person.

In further embodiments, a third person 53, for example the seller in the above example, may be provided with a headphone 54 which is connected to the messenger 20, or in particular, to the apparatus carried by a person 25 providing the messenger 20. The headphone 54 may be physically connected to the apparatus by a wire or wirelessly by a suitable communications protocol, such as Bluetooth, for example. At least the audio signals from the user to the third person 53 are inaudible to the person 25 carrying the apparatus of the messenger 20.

The network 11 may be the Internet and associated communication connections or a digital mobile telecommunications network such as a GSM network or by satellite communication. The messenger includes means for establishing a video connection between the messenger and the user via a network and transmitting and receiving instructions from the user so as to enable the messenger to control the field of view represented by the video signal in real time. The messenger may also include means for receiving, capturing and transmitting audio signals. These features may be provided by apparatus such as a smart phone or tablet PC which are equipped with a camera to capture and transmit visual images of the environment in front of the camera, software suitable to send these images in real time via a network and audio or video connection receiving means to receive instructions from the user so as to enable the messenger to control the field of view.

In some embodiments, the messenger 20 may include a hub 21, 22 which may be connected to one or more sub messengers. For example, the hub 21, 22 may be a computer and the administrator of the hub 21, 22 may transfer the assignment from the server 14 including the possible geographic geographical area of the object to be located to one or more of a plurality of people 25. A person 25 may carry apparatus for establishing a video connection with the user 13 and acts as the messenger 20 which establishes the video connection between an object which is to be located remote from the user 13 and the user 13.

Before starting the method, the user 13 does not have to know a suitable messenger 20, for example a messenger 20 geographically located within a predetermined distance of the possible geographic area of the location. The user 13 may select a suitable messenger 20 from the table 15 comprising messengers 20 having known locations. The user 13 may also remain anonymous from the messenger 20 as the messenger 20 may receive the assignment to proceed to a possible geographic area of the object from the server 14, rather than from the user 13. The video connection between the user 13 and the messenger 20 may also be established without the messenger 20 knowing the identity or geographic location of the user 13. Additionally, the identity of the messenger 20 in terms of personal details of a person or IP address may also be withheld from the user 13 via the use of a pseudonym, for example. One or both of these measures may be desirable to increase personal security.

The video connection and, if present, the audio connection, between the user 13 and the messenger 20 may be made via a network 43 that is independent of the network 11 comprising the server 14. For example, the request sent from the user 13 to the server 14 and from the server 14 to the messenger 20 may be sent over the Internet, whereas the video connection is set up directly between the messenger 20 and the user 13 without accessing the server 14. The video connection may be performed over a mobile communications network. However, the same network or other networks may be used for both of these connections.

If an Internet or GSM connection is not available in the possible geographic area of the object to be located, a suitable mobile repeater may be used to extend the range and capability of the system.

In some embodiments, the table 15 may comprise known fixed geographical locations of the messengers 20 and/or the table 15 may comprise the actual geographical location of the messengers 20. For example, the fixed geographical location of a messenger 20 may be an office location and the actual geographical location may be the actual location of the messenger 20 as determined by real-time GPS data. Both types of geographical location may be represented by GPS data, for example.

In some embodiments, the assignment sent to the messenger 20 from the server 14 further comprises a pre-selected point in time at which the messenger may be geographically located within the possible geographical area of the object. For example, the user 13 may reserve the messenger 20 to proceed to the possible geographic area at a future date, for example next Tuesday at 10 am GMT (Greenwich Mean Time). In some embodiments, the user 13 may also set a time frame over which they messenger 20 should be available, for example next Wednesday from 4 pm to 6 pm GMT.

In some embodiments, the table 15 may further include the availability of the messenger 20 as a function of time. For example the table 15 may include a work roster with time periods already booked for this messenger 20 indicated as unavailable timeslots.

If a plurality of messengers 20 is determined to have a geographical location within the predetermined distance of the possible geographic area, one of the plurality of messengers 20 may be selected based on one or more of a plurality of criteria including shortest distance to the possible geographic area, cost per hour, availability at a pre-selected time, availability for a pre-selected time frame, an area over which the messenger is mobile, specialist knowledge, languages spoken, and a performance rating given by previous users of the messenger 20.

If no messenger 20 is geographically located within the predetermined distance of the possible geographic area, the predetermined distance may be increased and the table accessed again. For example, if a predetermined distance of 10 km was first entered and no messenger was found to be within a radius of 10 km of the possible geographic area, the predetermined distance may be increased to 25 km, for example, and the table 15 searched again to determine if one or more messengers 20 are positioned within 25 km of the possible geographic area of the object.

In some embodiments, the assignment from the user 13 to the messenger 20 further comprise instructions to enable the messenger 20 to further alter the field of view of the video signal sent to the user 13 based on the instructions from the user 13. As discussed above, the method may be used to enable the user 13 to visually identify an object. If the object is not present in the field of view of the video signal first sent to the user 13, the user 13 can send instructions to the messenger 20 to modify the field of view transmitted to the user 13.

For example, the user 13 may send an assignment that the messenger 20 move systematically up and down the aisles of a supermarket until the desired object is located. In another example, the user 13 may send an assignment to the messenger 20 to alter the field of view of the video signal such that not only the front of a car may be observed, but subsequently, real-time images from the sides and rear of the vehicle as well as from the engine are transmitted to the user 13. In yet another example, the user 13 could send an assignment to the messenger 20 to search for an object in the form of a particular person or to proceed to a third person who may be able to provide additional information as to the geographical location of the object to be located.

In some embodiments, after the user 13 has identified the location of the object in the field of view, the messenger 20 may physically change the position of the object. For example, the messenger 20 may turn around the object so that the rear side of the object is in the field of view. Alternatively, the position of the object may be changed after the video connection ceases. For example, the video connection may be switched off and afterwards, the messenger takes the object to a cash desk in order to pay for it.

In embodiments in which the object is a physical article, the method may further comprise physically sending the object to the user 13.

The object may be packed and sent by means of a Postal Service or courier service to the user 13. The packing may be carried out by an intermediate. For example, the messenger 20 may take the object to the hub 21, 22 and the hub 21, 22 may be arranged for the packing and sending of the object to the user 13. In this embodiment, the hub 21, 22 may serve as the intermediate.

Alternatively, the messenger 20 or the hub 21, 22 may take the object to an intermediate that sends and, optionally, packs the object. These embodiments may be used to take advantage of specialist packing and courier services so as to efficiently send the object, undamaged, to the user 13.

The real-time video images may be sent by Audio and Video IP protocols .

The assignment from the user 13 to the messenger 20 may include audio signals.

As discussed above, a hub 21, 22 may be provided which is connected via the network 11 to the server 14, the hub 21, 22 being adapted to have access to a plurality of messengers 20. If a hub 21, 22 is provided, the hub 21, 22 may be included in the table 15 as a messenger 20 having a known geographical location.

In the case of a hub 21, 22, the assignment including the possible geographical area may be sent from the server 14 via the network 11 to the hub 21, 22 and from the hub 21, 22 to a messenger 20 enabling the messenger 20 to proceed to the possible geographic area.

In some embodiments, after the video connection is established between the messenger 20 and the user 13, a video or audio signal from the user 13 may be transmitted by the messenger 20 to a third party 53. This may be performed by placing a loudspeaker, coupled to the audio signal receiving means, in a suitable position such that an audio signal from the user 13 may be transmitted by the loudspeaker at a volume suitable that the third-party 53 can hear the audio signal from the user 13. An audio signal may be transmitted from the user 13 via the messenger 20 to a headphone 54. The headphone 54 may be worn by a third person 53 to whom the user 13 wishes to send audio signals and have a real-time conversation.

Alternatively, or in addition, after the video connection is established between the messenger 20 and the user 13, a video or audio signal from a third party may be transmitted by the messenger 20 to the user 13. The messenger 20 includes a microphone for capturing audio signals and means for converting the audio signals into data which may be transmitted via the network 11 to the user 13. This embodiment may be used to enable the user 13 to receive an audio signal from a third party 53 who is outside of the field of view of the real-time video image but within the operational distance of the microphone carried by the messenger 20. Therefore, the video connection and the audio connection, if present, may be unidirectional or bidirectional.

If the video connection further comprises an audio connection, real-time conversation may be sent over the video connection.

In some embodiments, the video connection between the messenger 20 and the user 13 may be established without accessing the server 14 storing the table 15 of messengers 20.

The method may further comprise sending the user 13 an address of the messenger 20. The address may be an IP address or an e-mail address or an Audio and/or Video IP protocol contact address such as a Skype address. The video connection may be established by the user 13 sending a query to the address of the messenger 20 which is accepted by the messenger 20 to establish the connection, for example.

The apparatus for receiving and sending video images over a network 11 is movable to change the field of view upon receipt of instructions from the user 13. The apparatus may be carried by the messenger 20, either in the hands or, in order to allow the messenger 20 to handle the goods, be attached to a part of the messenger's body other than the hands, for example, the forehead or the chest.

The apparatus may be a tablet PC 23, a touch screen PC or a smart phone 24, for example.

If the object to be remotely located is to be purchased by the user 13, the user 13 may receive an invoice for the sum to be paid for the object and for the service provided in remotely locating the object.

A file including data describing an invoice may be sent from the messenger 20 to the server 14 and an invoice may be sent to the user 13 from the server 14. The user 13 may send data suitable for authorizing payment of the invoice over a secure link to the server 14.

The route provided by the method for payment of the invoice may be different from the route provided to obtain the object. The invoice may be sent from the hub 21, 22 or messenger 20 via the server 14 to the user 13, whereas the connection between the user 13 and the messenger 20 used for locating the object in real time in a geographical location remote to the user may take place without access to the server 14.

The table 15 may also include the availability of the messenger 20 at one particular time or the availability of the messenger 20 over a future time span. The known geographical location may be a fixed location or may be the actual geographical location of the messenger 20. Both types of known geographical location may be included for a single messenger.

In the case of a system including a hub 21, 22, the hub 21, 22 may be included in the table 15 as a messenger 20. The messengers 20 that are assigned by the hub 21, 22 to proceed to the possible geographical area of the object may not be included in the table 15. In embodiments including a 21, 22, the hub 21, 22 finds messengers 20 which are geographically located and available to perform the assignments received.

The methods described herein may be used in a number of applications. For example, the methods may be used when househunting so that the user 13 can look at the details of the house, and assess the neighbourhood and environmental noise remotely. This may be useful if the user 13 is located at a large distance from the new house. The methods may also be used for remote visits to trade fairs and other events, remote visits to family members and remote hospital visits, for example. The methods may also be used to gain a real-time realistic view of objects such as vehicles, including classic cars, boats, aeroplanes, objects which are to be sold at auction, and other objects whose appearance is of interest, such as fashion, art, sculptures, documents, objects whose details are not known exactly such as consumer products including foodstuffs. The methods may also be used to gain an independent view of environments such as the environment within companies, factories, animal husbandry facilities, access facilities for the disabled, the elderly and the otherwise incapacitated.

The invention having been described herein with respect to certain specific embodiments, it will be understood that these embodiments are intended to illustrate, not limit, the scope of the appended claims.

1. A method for remotely locating an object in real time via a network, comprising:
receiving a request from a user at a server, wherein the request describes an object to be geographically located remotely from the user via the network;
identifying a possible geographic area in which the object is expected to be geographically located;
determining a messenger having a geographical location within a predetermined distance of the possible geographic area from a table comprising messengers having known geographical locations, the identity and geographical location of the user being unknown to the messenger;
sending an assignment including the possible geographical area from the server to the messenger enabling the messenger to proceed to the possible geographic area;
after the messenger is positioned within the possible geographic area, establishing a video connection between the messenger and the user via a network capable of transferring real-time video images, and
whilst a real-time video image is sent from the messenger to the user, relaying instructions from the user to the messenger to control a field of view represented by the video image in real-time to enable the user to visually determine whether the object is geographically located within the field of view.

2. The method according to claim 1, wherein
the table comprises known fixed geographical locations of the messengers.

3. The method according to claim 1, wherein
the table comprises the actual geographical location of the messengers.

4. The method according to claim 1, wherein
the assignment sent to the messenger from the server further comprises a pre-selected point in time at which the messenger is to be geographically located within the possible geographical area of the object.

5. The method according to claim 1, wherein
the table further includes the availability of the messenger as a function of time.

6. The method according to claim 1, wherein
if a plurality of messengers are determined to have a geographical location within the predetermined distance of the possible geographic area, selecting one of the plurality of messengers based on a plurality of criteria consisting of shortest distance to the possible geographic area, cost per hour, availability at a pre-selected time, availability for a pre-selected time frame, area over which the messenger is mobile, specialist knowledge, languages spoken and a performance rating.

7. The method according to claim 1, wherein
if no messenger is geographically located within the predetermined distance of the possible geographic area, increasing the predetermined distance and accessing the table again.

8. The method according to claim 1, wherein
identifying the possible geographic area in which the object is expected to be geographically located is based on information contained in the received request describing the possible geographic area in which the object is expected to be geographically located.

9. The method according to claim 1, wherein
the assignment further comprise instructions to enable the messenger to further alter the field of view of the video signal sent to the user based on the instructions from the user.

10. The method according to claim 1, further comprising
receiving an additional instruction from the user requesting that the messenger physically changes the position of the object.

11. The method according to claim 1, wherein
the assignment include audio signals.

12. The method according to claim 1, wherein the assignment is sent to the messenger via a hub connected via the network to the server, the hub being adapted to have access to a plurality of messengers.

13. (canceled)

14. The method according to claim 1, wherein
the video connection is unidirectional or bidirectional.

15. The method according to claim 1, wherein
real-time conversation is sent over the video connection.

16. The method according to claim 1, wherein
the the messenger is selected by the user from the table comprising messengers having known geographical locations stored by the server.

17. The method according to claim 1, wherein
the video connection between the messenger and the user is established without accessing the server storing the table of messengers.

18. The method according to claim 1, further comprising:
sending a file including data describing an invoice to the user.

19. The method according to claim 18, further comprising:
receiving data suitable for authorizing payment of the invoice over a secure link.

20. A server comprising:
receiver apparatus for receiving a request from a user, wherein the request describes an object to be geographically located remotely from the user and a possible geographic area in which the object is expected to be geographically located;
storage apparatus for storing a table comprising a plurality of messengers having known geographical locations;
determining apparatus for determining a messenger having a geographical location within a predetermined distance of the possible geographic area from the table, the identity and geographical location of the user being unknown to the messenger; and
transmitter apparatus for sending an assignment including the possible geographical area from the server to the messenger enabling the messenger to proceed to the possible geographic area.
